(19) United States
(12) Patent Application Publication
(10) Pub. No.: US 2009/0299765 A1
(43) Pub. Date: Dec. 3, 2009

(54) Device and Method for Selective Medical Record Releases

(75) Inventor: Nathaniel G. Martin, Rochester, NY (US)

Correspondence Address: Gibb Intellectual Property Law Firm, LLC, 2568-A Riva Road Suite 304, Annapolis, MD, 21401, US

(73) Assignee: Xerox Corporation, Norwalk, CT (US)

(21) Appl. No.: 12/128,820

(22) Filed: May 29, 2008

(51) Int. Cl. G06Q 50/00; G06Q 10/00

(52) U.S. Cl. 705/3

(57) ABSTRACT

A printing device includes a user interface that receives a patient identifier, and a communications port that contacts a database to obtain the history of healthcare providers of the patient. A processor prepares a form as an electronic document. On the form, each of the healthcare providers has a separate consent marking area. A printing engine is included to print the electronic document. A scanner is used to scan the printed document after the patient has placed markings in the consent marking areas of the form and has signed the form to create a scanned image. The processor can then process the scanned image to identify consented and non-consented healthcare providers. Then, the communications port can output the list of consented healthcare providers.

### BACKGROUND AND SUMMARY

Embodiments herein generally relate to method and apparatus embodiments that use a multi-function printing device to produce and scan a form to allow medical patients to selectively permit access to medical records.

A Regional Health Information Organization (RHIO) facilitates communications between healthcare organizations. Healthcare information is very sensitive and is protected the Health Information Portability and Accountability Act (HIPAA) which provides legal consequences for revealing such information. Therefore, there is a conflict between the goals of the RHIO and HIPAA. What neither option allows is the ability to tailor the information that will be accessible through the RHIO. U.S. Patent Publication 2006/0229911 (the complete disclosure of which is incorporated herein by reference) describes a system for providing a more finely grained control of access to medical records by maintaining a registry of healthcare document with access control information. The embodiments herein can be used to populate this registry and to perform many other activities.

More specifically, embodiments herein use a multi-function printer (MFP) whose controller is augmented with the capability to access RHIO information. In one example, a patient can provide some form of identifier, such as their insurance provider policy number and patient identification. This information is entered into the MFP. Information on all of the healthcare organizations that the patient has contact with is gathered and a form is created with check boxes that indicate whether each organization should have access to the data shared through the RHIO and whether the RHIO should provide access to the information maintained by this organization.

The form is printed and the patient can check off items on the form. The form is then scanned back into the multi-function printer and each of the organizations whose information the patient wishes to make available to the RHIO are notified, and access to those records is granted to the RHIO. Contrasted with purely electronic systems, with the embodiments herein by printing on paper the patient can take the form home and make choices in privacy then bring the form back to the healthcare provider's office.

The embodiments herein provide the automatic generation of a form created for an individual based on information maintained on that individual in external databases in order to provide that individual with a focused form. The purpose of this form is to capture approval to release medical information through a Health Information Exchange (HIE) such as a RHIO. Creation of such a personalized form is useful because the patient providing approval may not remember all of the locations at which they have records, yet such information exists in external databases. In addition, the patient is unlikely to know all of the places where such information is likely to be needed. However, lists containing this information is available in databases. In addition to allowing the patient to fill out the form at home, providing a paper copy of the form is useful in this case because it allows the capture of the patient's signature.

One specific method embodiment herein begins by receiving a patient identifier (e.g., policy number) into a user interface of a printing device. The printing device contacts a database to obtain a history of healthcare providers of the patient corresponding to the patient identifier. For example, the printing devices may contact the Regional Health Information Organization (RHIO) to collect a list of practices with which the information may be shared; it may contact the patients medical insurance company for a list of the practices with which the patient has interacted and is therefore likely to have information to share. Then an electronic document individualized for a particular patient can be prepared. The electronic document includes first consent marking areas for the patient to indicate consent or non-consent for healthcare providers from which prior patient medical records may be released and second consent marking areas for the patient to indicate consent or non-consent for healthcare providers to which the prior patient medical records may be released. Because the form is individualized, the patient need not remember all of the practices with which he or she has interacted-this information is on the form as extracted from the database. Each of the healthcare providers is provided with a separate consent marking area on the electronic document.

The electronic document is then printed by the printing device. After the patient has placed markings in the consent marking areas of the printed document, the document is placed on the scanner of printing device so that it can be scanned. The scanned image is processed (potentially by the printing device itself) to identify consented healthcare providers and non-consented healthcare providers. Then, the printing device can output the list of the consented healthcare providers to the HIE (potentially to the Regional Health Information Organization maintained database). The HIE uses this list to update its access control list giving access to information in the records.

A number of apparatus embodiments are contemplated herein. One such apparatus embodiment includes a processor executing instructions stored on a computer storage media. A user interface is connected to the processor, and receives the patient identifier. In addition, the apparatus can include a communications port connected to the processor that contacts the database to obtain the history of healthcare providers of the patient. Again, the database can comprise a Regional Health Information Organization maintained database that is connected to the communications port through a network external to the printing device.

The processor prepares the electronic document. Once again, this electronic document can include first consent marking areas for the patient to indicate consent or non-consent for the healthcare providers from which prior patient medical records may be released, and second consent marking areas for the patient to indicate consent or non-consent for healthcare providers to which the prior patient medical records may be released. On the form, each of the healthcare providers is provided a separate consent marking area to allow the patient to selectively choose to grant access to or from each health-care provider individually.

A printing engine is included within the printing device and is connected to the processor, and prints the electronic document. The printing device also includes a scanner connected to the processor. The scanner is used to scan the printed document after the patient has placed markings in the consent marking areas of the form and has signed the form to create a scanned image. The processor can then process the scanned image to identify consented and non-consented healthcare providers. Then, the communications port can output the list of consented healthcare providers (potentially to the Regional Health Information Organization maintained database).

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating embodiments herein.

FIG. 2 is a schematic diagram of a form according to embodiments herein; and

FIG. 3 is a schematic diagram of multi-function printing device according to embodiments herein.

### DETAILED DESCRIPTION

A Regional Health Information Organization (RHIO) shares data among many healthcare organizations including hospitals, clinics, pharmacies, labs and insurance companies. There are significant safety advantages to sharing such information. For example, drug interactions between prescriptions from multiple doctors filled at different pharmacies can be caught and detailed information on existing medical conditions stored in multiple databases can be called up quickly in an emergency. On the other hand, people consider healthcare information private and such information can be damaging. For example, knowledge of treatment for mental health issues or AIDS can cause discrimination against patients. Currently patients can only choose to share their medical information either with every entity in the RHIO or with none of them. The embodiments herein allow the patient to exercise greater control over who gets access to their data and what data is shared. The embodiments herein make it easier for the patient to indicate their preferences.

Therefore, the embodiments herein can take the form of a Multi-Function Printer (MFP) with a controller augmented to access the healthcare providers the patient has used in the past. This information is available, for example, from the insurance company covering the patient. The MFP then produces a form personalized to the patient indicating all of the places healthcare information may be available and all of the places healthcare information may be needed.

The checkboxes can be associated with machine readable code. The patient checks the information he or she would like to be shared through the RHIO and which healthcare organization he or she would like to share this information with. The form is then scanned back into the MFP and the image is process to determine which elements have been checked. The MFP sends the information on the elements that have been checked to the RHIO. The RHIO then allows access to the data the patient has approved for sharing among the offices the patient has approved to receive the data.

One workflow example embodiment is now discussed. In this workflow, the patient provides an insurance policy number and provider, and the insurance policy number and provider are entered into the MFD. The MFD prints a form containing a) checkboxes to allow (or disallow) access to information at sites the patient has visited; and b) checkboxes to allow access to information through the RHIO for healthcare services the patient might access. The patient then checks off elements in the form and the patient signs the form and someone from the healthcare organization witnesses it. The form is scanned back into the MFD. Note this workflow could be used with a registry (such as described in U.S. Patent Publication 2006/0229911). In such as case, the patent provides authentication to the registry. This authentication would be entered into the MFD. An advantage of accessing the insurance company is that no new registry needs to be set up.

With respect to a device and method, as mentioned above, the device can be an MFD having a controller that can perform the following processing. This process may be executed on the MFD itself, or on a server accessible through the controller. In the process, the RHIO opt-in (opt-out) application is selected to run, an insurance provider and policy number are entered into the device, and the MFD authenticates itself with the insurance provider entered and provides the policy number entered. The MFD receives a reply from the insurance provider that includes a list of healthcare providers the patient has used.

From this the MFD creates a form comprising a) the list of healthcare providers with two check boxes next to each provider name (one indicating that the patient wishes to allow access to information; the other indicating that the patient wishes to allow information to be provided); and b) a list of healthcare providers the patient has not used, but which he or she may wish to use (e.g., emergency department in hospitals). The MFD then prints the form and, after the patient has filled in the form, the form is scanned into the MFD.

The scanned image is processed to produce two lists: the list of organization allowed access to information maintained by the RHIO; and the list of organization that are allowed to make information available to the RHIO. The image of the form (containing the patient's and witness's signatures) and the two lists are delivered to the RHIO. The RHIO's address and the format the RHIO needs can be coded in the machine.

When this patient consent data is provided to the RHIO, the policy manager for the RHIO system for facilitating information exchange is updated to allow access by the healthcare organization authorized by the patient. In addition, the policy manager is updated to indicate which information sources can be accessed. Download of the information can be controlled (if the RHIO is centralized) or access to the database can be controlled (if the RHIO is federated).

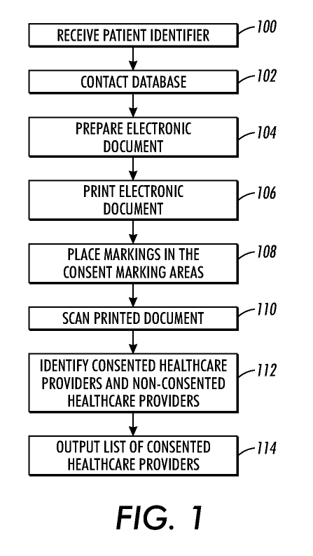

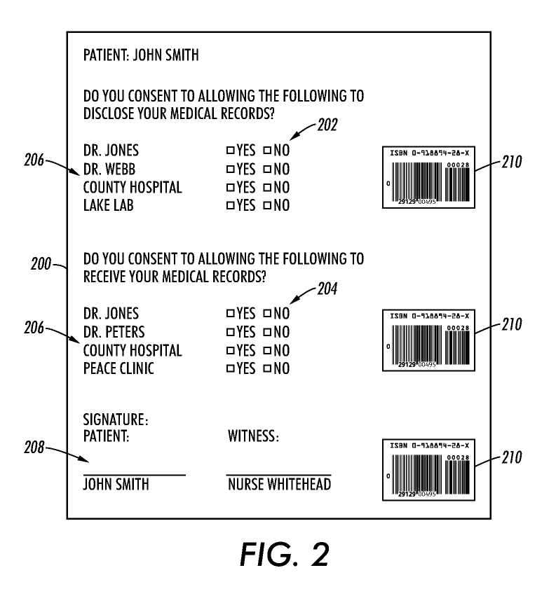

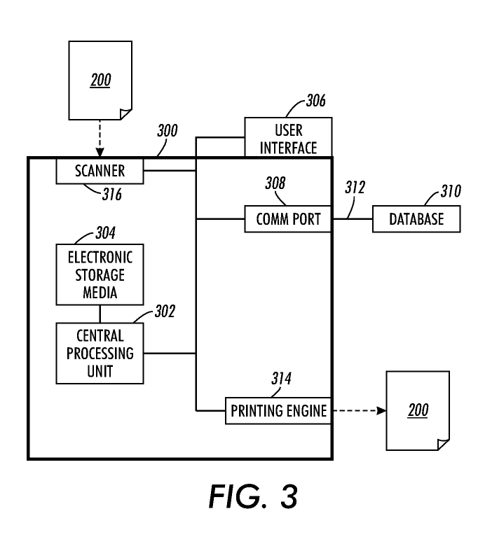

These concepts are illustrated in the flowchart in FIG. 1, the form document is shown in FIG. 2, and in the apparatus is shown in FIG. 3. More specifically, in item 100 in FIG. 1, the process begins by receiving a patient identifier (e.g., policy number) into a user interface of a printing device. Then in item 102, the printing device contacts a database (e.g., Regional Health Information Organization maintained database) to obtain a history of healthcare providers of the patient that corresponds to the patient identifier. For example, in the current configuration of HIE and insurance databases in the United States, the RHIO can provide the practice that might access the information; the insurance company can provide the practices with which the patient has a relationship. After acquiring the individual patient's records and the practices with which the patient may interact, an electronic document can be prepared in item 104.

As shown in FIG. 2, the electronic document form 200 includes first consent marking areas 202 for the patient to indicate consent or non-consent for healthcare providers from which prior patient medical records may be released. The form also includes second consent marking areas 204 for the patient to indicate consent or non-consent for healthcare providers to which the prior patient medical records may be released. As shown in FIG. 2, each of the healthcare providers 206 have a separate consent marking area on the electronic document because the patient may wish to allow some providers access to some records while restricting other's access to the same records. In addition, the form includes signature areas 208 for the patient, guardian/parent, and witness and some form of machine-readable markings 210 (such as bar codes or glyphs). Those ordinarily skilled in the art would understand that FIG. 2 is only an example and that the form could be formatted in any manner desired and could include more or less information (such as advice notices, legal notices, warnings, etc.)

Referring again to FIG. 1, in item 106 the electronic document 200 is then printed by the printing device. After the patient has placed markings in the consent marking areas of the printed document in item 108, the document is placed on the scanner of printing device so that it can be scanned in item 110. The scanned image is processed (potentially by the printing device itself) to identify consented healthcare providers and non-consented healthcare providers in item 112. The processing in item 112 can comprise many different methods including optical character recognition (OCR), machine-readable marks next to each potential response, etc. Alternatively, a single machine-readable marking 210 can allow the form to be identified to permit interpretation of the patient's responses. Then, the printing device can output the list of the consented healthcare providers (potentially to the Regional Health Information Organization maintained database) in item 114. The HIE updates its access control list in compliance with the list of consented healthcare providers to allow access only by the providers indicated, to the records of the practices indicated.

A number of apparatus embodiments are contemplated herein. One such apparatus embodiment 300 is shown in FIG. 3 and includes a processor (e.g., central processing unit (CPU)) 302 executing instructions stored on a computer storage media 304. A user interface 306 is connected to the processor 302, and receives the patient identifier corresponding to the patient. In addition, the apparatus 300 can include a communications port 308 connected to the processor 302 that contacts the database 310 to obtain the history of healthcare providers of the patient. Again, the database 310 can comprise a Regional Health Information Organization maintained database 310 that is connected to the communications port 308 through a network 312 external to the printing device 300.

The processor 302 prepares the electronic document 200. A printing engine 314 is included within the printing device 300 and is connected to the processor 302, and prints the electronic document 200. The printing device 300 also includes a scanner 316 connected to the processor 302. The scanner 316 is used to scan the printed document 200 after the patient has placed markings in the consent marking areas of the form and has signed the form to create a scanned image. The processor 302 can then process the scanned image to identify consented and non-consented healthcare providers. Then, the communications port 308 can output the list of consented healthcare providers (potentially to the Regional Health Information Organization maintained database 310).

Many computerized devices and printers are discussed above. Many forms of printing devices are currently available from manufactures such as Xerox Corporation, Norwalk, Conn., USA. Computerized devices that include chip-based central processing units (CPU's), input/output devices (including graphic user interfaces (GUI), memories, comparators, processors, etc. are well-known and readily available devices produced by manufactures such as International Business Machines Corporation, Armonk N.Y., USA and Apple Computer Co., Cupertino Calif., USA. Such computerized devices and printers commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and Visioneer, Inc. Pleasanton, Calif., USA and the details of such devices are not discussed herein for purposes of brevity and reader focus.

The words printer, printing device, output device, etc., as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

When used herein, the term automatic or automatically means that a system or method performs the action without requiring any further user input and occurs as the result of some action being completed or some state being achieved.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the invention should not be implied or imported from any above example as limitations to any particular order, number, position, size, shape, angle, color, or material.

What is claimed is:

1. A method comprising:
receiving a patient identifier into a user interface of a printing device;
contacting, by said printing device, a database to obtain a history of healthcare providers of a patient corresponding to said patient identifier;
preparing an electronic document comprising consent marking areas for said patient to indicate consent or non-consent to release medical records of said patient from said healthcare providers, each of said healthcare providers having a separate consent marking area on said electronic document;
printing, from said printing device, said electronic document as a printed document;
after said patient has placed markings in said consent marking areas of said printed document, scanning, by said printing device, said printed document to create a scanned image;
processing said scanned image to identify consented healthcare providers and non-consented healthcare providers; and
outputting a list of said consented healthcare providers.

2. The method according to claim 1, said database comprising a Regional Health Information Organization (RHIO) maintained database.

3. The method according to claim 1, said processing of said scanned image being performed by said printing device.

4. The method according to claim 1, said patient identifier comprising a medical insurance policy number.

5. The method according to claim 1, said printing device comprising a stand-alone multi-function printer.

6. A method comprising:
receiving a patient identifier into a user interface of a printing device;
contacting, by said printing device, a database to obtain a history of first healthcare providers of a patient corresponding to said patient identifier;
automatically preparing, by said printing device, an electronic document comprising:
first consent marking areas for said patient to indicate consent or non-consent for said first healthcare providers from which prior patient medical records may be released; and
second consent marking areas for said patient to indicate consent or non-consent for second healthcare providers to which said prior patient medical records may be released,
each of said first healthcare providers and said second healthcare providers having a separate consent marking area on said electronic document;
printing, from said printing device, said electronic document as a printed document;
after said patient has placed markings in said first consent marking areas and said second consent marking areas of said printed document, scanning, by said printing device, said printed document to create a scanned image;
processing said scanned image to identify consented first healthcare providers and non-consented first healthcare providers and to identify consented second healthcare providers and non-consented second healthcare providers; and
outputting a list of said consented first healthcare providers and said consented second healthcare providers.

7. The method according to claim 6, said database comprising a Regional Health Information Organization (RHIO) maintained database.

8. The method according to claim 6, said processing of said scanned image being performed by said printing device.

9. The method according to claim 6, said patient identifier comprising a medical insurance policy number;

10. The method according to claim 6, said printing device comprising a stand-alone multi-function printer.

11. An apparatus comprising:
a computer storage media;
a processor operatively connected to said computer storage media and executing instructions stored on said computer storage media;
a user interface operatively connected to said processor, said user interface receiving a patient identifier;
a communications port operatively connected to said processor that contacts a database to obtain a history of healthcare providers of a patient corresponding to said patient identifier, said processor preparing an electronic document comprising consent marking areas for said patient to indicate consent or non-consent to release medical records of said patient from said healthcare providers, each of said healthcare providers having a separate consent marking area on said electronic document;
a printing engine operatively connected to said processor, said printing engine printing said electronic document as a printed document; and
a scanner operatively connected to said processor, said scanner scanning said printed document after said patient has placed markings in said consent marking areas of said printed document to create a scanned image,
said processor processing said scanned image to identify consented healthcare providers and non-consented healthcare providers, and
said communications port outputting a list of said consented healthcare providers.

12. The apparatus according to claim 11, said database comprising a Regional Health Information Organization (RHIO) maintained database connected to said communications port through a network external to said apparatus.

13. The apparatus according to claim 12, said communications port outputting said list of consented healthcare providers to said RHIO maintained database.

14. The apparatus according to claim 11, said patient identifier comprising a medical insurance policy number.

15. The apparatus according to claim 11, said apparatus comprising a stand-alone xerographic or electrostatic multi-function printing device.

16. An apparatus comprising:
a computer storage media;
a processor operatively connected to said computer storage media and executing instructions stored on said computer storage media;
a user interface operatively connected to said processor, said user interface receiving a patient identifier;
a communications port operatively connected to said processor that contacts a database to obtain a history of healthcare providers of patient corresponding to said patient identifier, said processor preparing an electronic document comprising
first consent marking areas for said patient to indicate consent or non-consent for said first healthcare providers from which prior patient medical records may be released, and
second consent marking areas for said patient to indicate consent or non-consent for second healthcare providers to which said prior patient medical records may be released,
each of said first healthcare providers and said second healthcare providers having a separate consent marking area on said electronic document;
a printing engine operatively connected to said processor, said printing engine printing said electronic document as a printed document; and
a scanner operatively connected to said processor, said scanner scanning said printed document after said patient has placed markings in said first consent marking areas and said second consent marking areas of said printed document to create a scanned image,
said processor processing said scanned image to identify consented first healthcare providers and non-consented first healthcare providers and to identify consented second healthcare providers and non-consented second healthcare providers, and
said communications port outputting a list of said consented first healthcare providers and said consented second healthcare providers.

17. The apparatus according to claim 16, said database comprising a Regional Health Information Organization (RHIO) maintained database connected to said communications port through a network external to said apparatus.

18. The apparatus according to claim 17, said communications port outputting said list of consented healthcare providers to said RHIO maintained database.

19. The apparatus according to claim 16, said apparatus comprising a stand-alone xerographic or electrostatic multi-function printing device.

20. A computer program product comprising:
a computer-usable data storage medium storing instructions that, when executed by a computer, cause the computer to perform a method comprising:
receiving, from a patient, a patient identifier into a user interface of a printing device;
contacting, by said printing device, a database to obtain a history of healthcare providers of said patient;
preparing an electronic document comprising consent marking areas for said patient to indicate consent or non-consent to release medical records of said patient, each of said healthcare providers having a separate consent marking area on said electronic document;
printing, from said printing device, said electronic document as a printed document;
after said patient has placed markings in said consent marking areas of said printed document, scanning, by said printing device, said printed document to create a scanned image;
processing said scanned image to identify consented healthcare providers and non-consented healthcare providers; and
obtaining said medical records of said patient from said consented healthcare providers.
